(19) United States
(12) Patent Application Publication
(10) Pub. No.: US 2010/0053593 A1
(43) Pub. Date: Mar. 4, 2010

(54) APPARATUS, SYSTEMS, AND METHODS FOR ROTATING A LIDAR DEVICE TO MAP OBJECTS IN AN ENVIRONMENT IN THREE DIMENSIONS

(75) Inventors: Saad J. Bedros, West St. Paul, MN (US); Jathan W. Manley, St. Paul, MN (US); Robert A. Touchton, Jacksonville Beach, FL (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/198,679

(22) Filed: Aug. 26, 2008

(51) Int. Cl. G01C 3/08

(52) U.S. Cl. 356/5.01

(57) ABSTRACT

Apparatus, systems, and methods for perceiving objects in an environment in three dimensions are provided. One apparatus includes a turntable capable of being coupled to a vehicle and a light detection and ranging (LIDAR) device mounted on the turntable. A system includes a vehicle with a turntable coupled to the vehicle and a LIDAR device mounted on the turntable. One method includes rotating a two-dimensional LIDAR device along an axis of rotation that is substantially normal to a ground plane beneath the vehicle, capturing data points of objects within the environment surrounding the LIDAR device, and generating a three-dimensional representation of the objects based on the data points.

### FIELD OF THE INVENTION

The present invention generally relates to electronic mapping of a surrounding environment, and more particularly relates to apparatus, systems, and methods for rotating a two-dimensional light detection and ranging (LIDAR) device to map objects in an environment in three dimensions.

### BACKGROUND OF THE INVENTION

Developing autonomous vehicles that are capable of safely navigating through an environment has been a subject of research for several years. One difficulty encountered with many previous autonomous vehicles has been the ability to accurately detect objects in three dimensions while the vehicle is in motion with sufficient detail that those objects can be identified as an obstacle, a landmark (for use in navigation), or as inconsequential. Without this information an autonomous vehicle is unlikely to avoid such obstacles while traveling through an environment, whether the obstacles are on and/or above ground-level, or are in the form of potholes, runouts, and ditches (so-called negative obstacles). Furthermore, without the ability to identify landmarks, the position and orientation of an autonomous vehicle is difficult for the autonomous vehicle to determine.

Accordingly, it is desirable to provide perception apparatus, systems, and methods that are capable of detecting objects in three dimensions so that a vehicle may be autonomously navigated through an environment. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various embodiments of the invention provide perception apparatus for a vehicle. One perception and navigation apparatus comprises a turntable capable of being coupled to the vehicle and a light detection and ranging (LIDAR) device mounted on the turntable.

Perception and navigation systems are also provided. A perception and navigation system comprises a vehicle and a turntable coupled to the vehicle. The perception and navigation system further comprises a LIDAR device mounted on the turntable.

Various embodiments of the invention also provide object perception methods for a vehicle in an environment having a ground. One object perception method comprises the steps of rotating a two-dimensional LIDAR device along an axis of rotation that is substantially normal to a ground plane beneath the vehicle, capturing data points of objects within the environment surrounding the LIDAR device, and generating a three-dimensional representation of the objects based on the data points.

### BRIEF DESCRIPTION OF THE DRAWINGS

The present invention will hereinafter be described in conjunction with the following drawing figures, wherein like numerals denote like elements, and

FIG. 1 is a diagram of one embodiment of a system for perceiving objects in an environment and for navigating through the environment;

FIG. 2 is a diagram illustrating the where obstacles and landmarks are detected by a LIDAR device included in a perception apparatus in the system of FIG. 1; and

FIG. 3 is a diagram illustrating one embodiment for determining the distance and the height of an obstacle or landmark using the LIDAR device of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various embodiments of the invention provide perception and navigation apparatus, systems, and methods. One perception and navigation apparatus comprises a turntable capable of being coupled to the vehicle and a light detection and ranging (LIDAR) device mounted on the turntable. A perception and navigation system comprises a vehicle with a turntable coupled to the vehicle and a LIDAR device mounted on the turntable. One perception and navigation method comprises the steps of rotating a LIDAR device along an axis of rotation that is substantially normal to a ground plane beneath the vehicle and capturing 3-dimensional images of objects within the environment surrounding the LIDAR device.

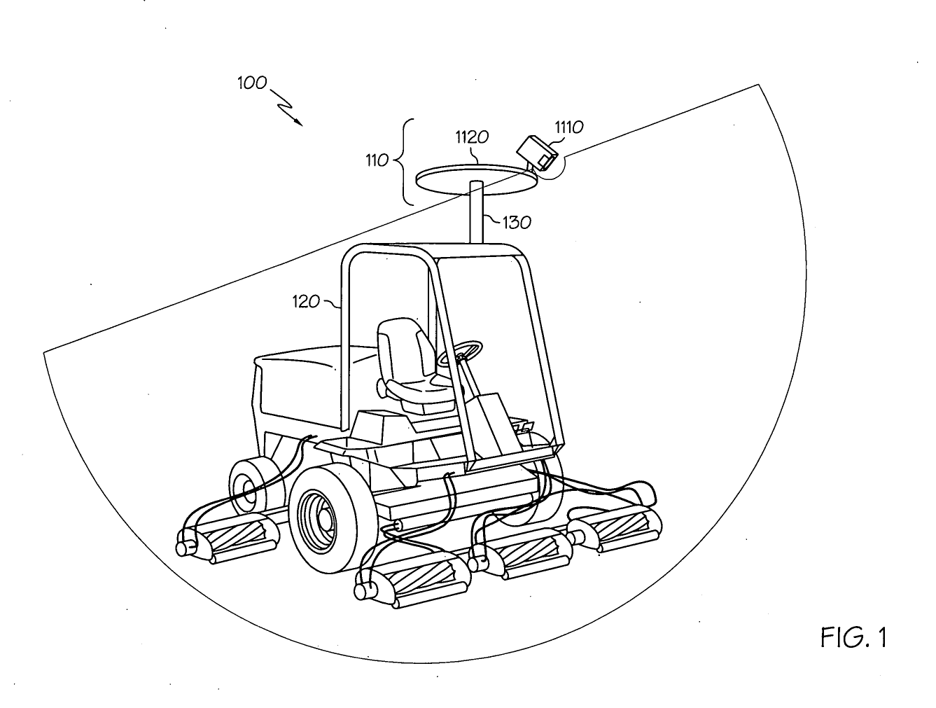

Turning now to the figures, FIG. 1 is a diagram of one embodiment of a system 100 for perceiving objects in an environment and navigating through the environment. At least in the illustrated embodiment, system 100 includes a perception apparatus 110 mounted to a vehicle 120 via a mounting structure 130 (e.g., a spindle or other structure capable of supporting perception apparatus 110).

Perception apparatus 110 comprises one or more LIDAR devices 1110 (e.g., two LIDAR devices, three LIDAR devices, four LIDAR devices, etc.) mounted on a turntable 1120. Each LIDAR device 1110 may be any LIDAR device known in the art or developed in the future. In one embodiment, LIDAR device 1110 is a LIDAR device manufactured by SICK, Inc. of Waldkirch, Germany, which includes among other models, model number LMS221-30206. In another embodiment, LIDAR device 1110 is a Spinning Line Laser Rangefinder (SPLINE) manufactured by RedZone Robotics, Inc. of Pittsburg, Pa. Other embodiments may use a LIDAR device 1110 manufactured by another entity. LIDAR device 1110 may be adjustably mounted on turntable 1120 via any adjustable means known in the art or mounted to turntable 1120 in a fixed position.

Turntable 1120 may be any system, device, or combinations thereof including a platform that is capable of rotating 360 degrees and is capable of having LIDAR device 1110 mounted thereon. That is, turntable 1120 includes a suitable structure so that when LIDAR device 1110 is mounted on turntable 1120, LIDAR device 1110 rotates along an axis of rotation created by the rotation of turntable 1120.

In the illustrated embodiment, LIDAR device 1110 is mounted on the perimeter of turntable 1120. In another embodiment, LIDAR device 1110 is mounted to turntable 1120 at a position between the center and the perimeter of turntable 1120. In these embodiments, turntable 1120 is configured to rotate at a rate of speed based on the type of LIDAR device 1110 used such that LIDAR device 1110 is capable of detecting the maximum number of objects per revolution. In one embodiment, LIDAR device 1110 is rotated at a rate of about 1.1 Hz, although other rates greater than or less than 1.1 Hz may be used. In another embodiment, the rate at which LIDAR device 1110 scans and the rate at which turntable 1120 rotates may be, individually or collectively, adjustable based on the rate of speed at which vehicle 120 is traveling.

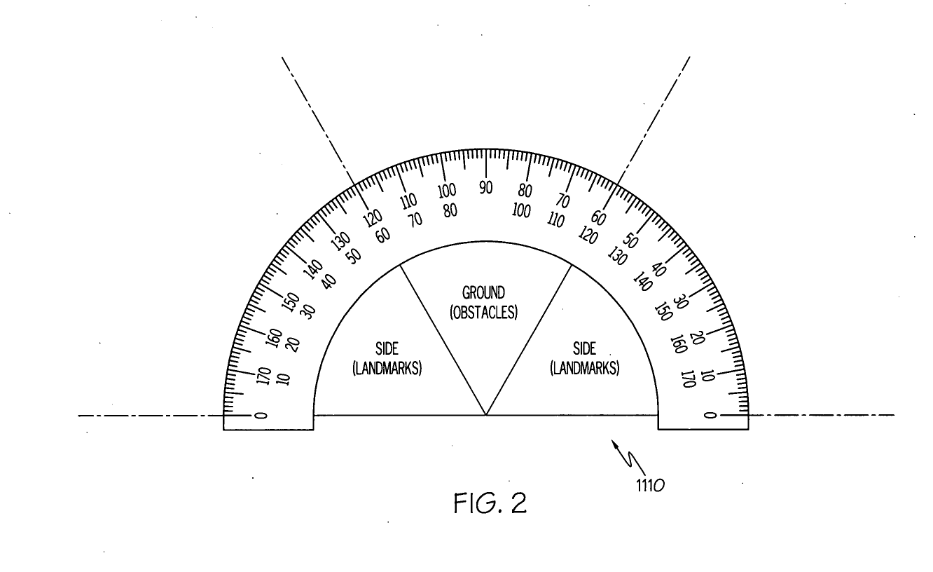

In one embodiment, LIDAR device 1110 is mounted on turntable 1120 such that LIDAR device 1110 is tilted at an angle that is below or at horizontal (i.e., 0-90 degrees) with respect to the axis of rotation created by LIDAR device 1110. That is, turntable 1120 is configured such that the axis of rotation of turntable 1120 is normal with respect to the ground (or ground plane) and LIDAR device 1110 is aimed at the ground or ground plane a predetermined distance away from turntable 1120 to create an angle between LIDAR device 1110 and the ground plane. In this embodiment, because the laser inside LIDAR device 1110 rotates the angle at which LIDAR device 1110 is pointed at the ground plane enables LIDAR device 1110 to detect objects (or obstacles) on or near the ground plane and landmarks to the sides of vehicle 120 in, for example, the x and z planes. Specifically, and with reference to FIG. 2, the unobstructed incidence of the laser points oriented at or near the center portion of LIDAR device 1110 are utilized to detect object (or obstacles) that are located on, near, or that are protruding from the ground plane (e.g., the x and z planes). Similarly, the unobstructed incidence of the laser points oriented in both of the non-center portions of LIDAR device 1110 are utilized to detect objects (or landmarks) that are located at or near the horizon, and objects (or landmarks) that are protruding from the ground plane and objects (or landmarks) that are hanging down from above (e.g., the x and z planes). For example, if a lamppost is 1 meter from vehicle 120 each of the laser points in LIDAR device 1110 will detect the lamppost are LIDAR device 1110 rotates; however, the height at which each laser point hits the lamppost will be different because of the angle at which LIDAR device 1110 is pointed at the ground plane.

Furthermore, the rotation of LIDAR device 1110 enables LIDAR device 1110 to detect objects (both obstacles and landmarks) that are located in the y plane. As such, while LIDAR device 1110 is rotating, LIDAR device 1110 is able to detect obstacles and landmarks in the x, y, and z planes.

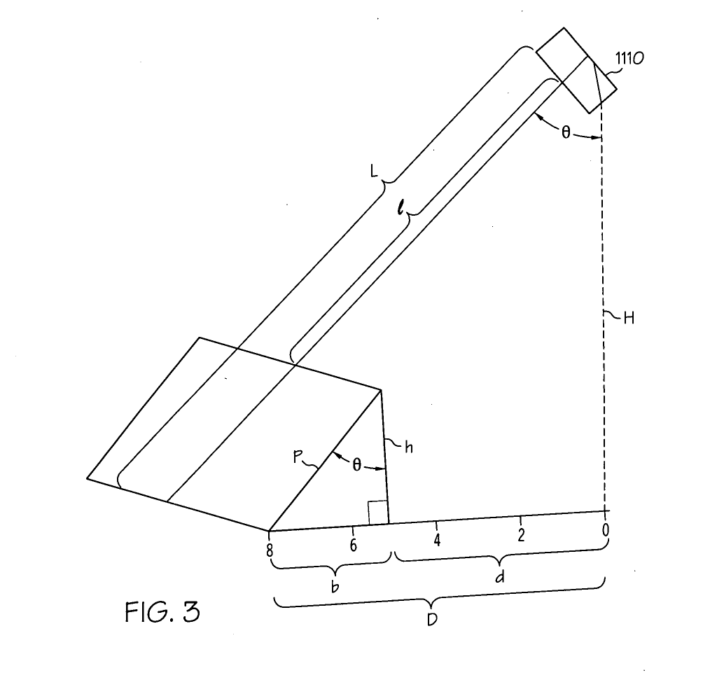

The distance an obstacle or landmark is away from LIDAR device 1110 may be calculated using simple geometry and/or other mathematical algorithms. In one embodiment and with reference to FIG. 3, the height (H) that LIDAR device 1110 is above the ground is known since LIDAR device 1110 is mounted on vehicle 120, as well as the pre-determined distance (D) that LIDAR device 1110 is scanning, and the angle (θ) at which LIDAR device 1110 is mounted to turntable 1120. Since H, D, and θ are known, the unobstructed scan length (L) can be determined using any number of techniques known in the art, the simplest of which rely on an assumption that the ground is flat. When an obstacle (or landmark) is detected, the height (h) of the obstacle can be calculated by subtracting the distance (l) to the obstacle calculated by LIDAR device 1110 from the predetermined scan distance, L, to generate the hypotenuse (P) of the detected obstacle (i.e., P=L−1). Since the angle (θ) is known, the height, h, of the detected obstacle can be calculated using the equation: h=P(sin (θ)). With P and H known, the base (b) of the triangle created by the detected obstacle can be calculated using the following equation: b=(P²−h²)^{1/2}. The base (b) can then be subtracted from the pre-determined distance, D, to determine the distance (d) to the object (i.e., d=D−b) along the ground plane. Negative obstacles (e.g., potholes, runouts, ditches, etc.) may be calculated in a similar manner except that h will represent the depth of the negative obstacle and P will represent the distance beyond the unobstructed scan length, L. Other negative obstacles (e.g., tree branches) may also be calculated in a similar manner except that h will represent the height at which the obstacle is hanging down since the laser points for detecting objects near the ground will not detect the object. As one skilled in the art will recognize, the above example is but one method of determining h and d, and that various embodiments of the invention contemplate any calculation technique and/or process capable of determining h and d.

Furthermore, LIDAR device 1110 includes a laser point at, for example, 0.5 degree increments from 0° to 180° for a total of 360 laser points. That is, the above discussion regarding determining h and d may be applied to each laser point such that data points for obstacles and landmarks may be generated by a plurality of laser points. As such, perception apparatus 110 may include processing and storage means for collecting and storing the data points detected by LIDAR device 1110.

In addition, the rotation of LIDAR device 1110 on the axis of rotation created by turntable 1120 enables LIDAR device 1110 to detect objects in the, for example, y plane. That is, when LIDAR device 1110 is rotating via turntable 1120, LIDAR device 1110 is capable of detecting objects in the x, y, and z axes surrounding vehicle 120. In other words, LIDAR device 1110 is capable of generating a 3-dimensional (3D) image of the environment surrounding vehicle 120 based on data points gathered during each revolution since LIDAR device 1110 is a two-dimensional LIDAR device generating data points in the x and z planes, and the rotation of LIDAR device 1110 enables data points in the y plane to be detected. That is, perception apparatus 110 is capable of generating a 3D map (or volume equivalent) of a particular environment surrounding vehicle 120 while vehicle 120 is operating.

In generating the 3D map, the position of LIDAR device 1110 along the axis of rotation is tracked. To do such, various embodiments of perception apparatus 110 may include a sensor axle or encoder (each not shown) that records the position of LIDAR device 1110 or where in terms of time in the rotation cycle LIDAR device 1110 is, respectively, when each data point is collected.

In another embodiment, LIDAR device 1110 is mounted on turntable 1120 such that LIDAR device 1110 is tilted at an angle that is above horizontal (e.g., 91-180 degrees) with respect to the axis of rotation created by LIDAR device 1110. For example, the axis of rotation of turntable 1120 is normal with respect to the ground and LIDAR device 1110 aimed at the sky (or a plane above turntable 11120) a predetermined distance away from turntable 1120 such that LIDAR device 1110 is capable of detecting objects above and to the sides of vehicle 120 when turntable 1120 is rotating.

In summary, the angle at which LIDAR device 1110 is directed dictates the range at which objects may be detected and the height of LIDAR device 1110 is mounted to vehicle 120 determines the distance at which landmarks may be detected. In any case, LIDAR device 1110 should be pointed such that occlusion of the light beams from LIDAR device 1110 by portions of vehicle 120 (which in essence creates a shadow) is minimized.

In the illustrated embodiment, vehicle 120 is a lawnmower. In other embodiments, vehicle 120 may be a motor vehicle (e.g., an automobile, truck, etc.), an aircraft, a spacecraft, a watercraft, or other similar vehicle. In one embodiment, vehicle 120 includes navigation apparatus and/or systems (not shown) that are capable of autonomously navigating vehicle 120 in an environment based on any objects (e.g., obstacles and/or landmarks) detected by perception apparatus 110. In other words, vehicle 120 may be an unmanned vehicle.

The following example may be helpful in better understanding the operations of system 100. As vehicle 120 travels, perception apparatus 110 detects the objects (e.g., obstacles and/or landmarks) in the environment surrounding vehicle 120 and is also capable of determining the translation characteristics of the environment surrounding vehicle 120. That is, perception apparatus 110 is capable of generating a 3D map (or volume equivalent) of a particular environment surrounding vehicle 120 while vehicle 120 is operating. The navigation apparatus/systems then control the movement of vehicle 120 through the environment based on the objects detected by perception apparatus 110. That is, vehicle 120 is capable of autonomously traveling through the environment using detected landmarks and avoiding detected obstacles (including negative obstacles) detected by perception apparatus 110.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A perception apparatus for a vehicle, comprising:
a turntable capable of being coupled to the vehicle; and
a light detection and ranging (LIDAR) device mounted on the turntable.

2. The perception apparatus of claim 1, wherein the LIDAR device is mounted on a perimeter of the turntable.

3. The perception apparatus of claim 1, wherein the LIDAR device is mounted at a location between a center and a perimeter of the turntable.

4. The perception apparatus of claim 1, wherein the turntable is capable of being mounted on the vehicle such that the turntable includes an axis of rotation that is substantially normal to a ground plane beneath the vehicle.

5. The perception apparatus of claim 4, wherein the LIDAR device is mounted at an angle below horizontal with respect to the turntable.

6. The perception apparatus of claim 4, wherein the LIDAR device is mounted at an angle above horizontal with respect to the turntable.

7. The perception apparatus of claim 1, further comprising an adjustable mounting means coupled to the turntable, wherein the LIDAR is mounted to the adjustable mounting means and the mounting means is configurable to modify an angle at which the LIDAR device is pointed.

8. A perception and navigation system, comprising:
a vehicle;
a turntable coupled to the vehicle; and
a light detection and ranging (LIDAR) device mounted on the turntable.

9. The perception and navigation system of claim 8, wherein the turntable is coupled to the vehicle such that an axis of rotation of the turntable is normal with respect to a ground plane beneath the vehicle.

10. The perception and navigation apparatus of claim 9, wherein the LIDAR device is mounted at an angle below horizontal with respect to the axis of rotation.

11. The perception and navigation apparatus of claim 9, wherein the LIDAR device is mounted at an angle above horizontal with respect to the axis of rotation.

12. The perception and navigation apparatus of claim 9, further comprising an adjustable mounting means coupled to the turntable, wherein the LIDAR is mounted to the adjustable mounting means and the mounting means is configurable to modify an angle at which the LIDAR device is pointed with respect to the axis of rotation.

13. The perception and navigation system of claim 8, wherein the LIDAR device is mounted on a perimeter of the turntable.

14. The perception and navigation system of claim 8, wherein the LIDAR device is mounted on a center of the turntable.

15. The perception and navigation system of claim 5, wherein the LIDAR device is mounted at a location between a center and a perimeter of the turntable.

16. An object perception method for a vehicle in an environment having a ground, the perception and navigation method comprising the steps of:
rotating a two-dimensional light detection and ranging (LIDAR) device along an axis of rotation that is substantially normal to a ground plane beneath the vehicle;
capturing data points of objects within the environment surrounding the LIDAR device; and
generating a three-dimensional representation of the objects based on the data points.

17. The object perception method of claim 16, wherein the rotating step comprises the step of rotating the LIDAR device greater than 180 degrees along the axis of rotation.

18. The object perception method of claim 16, wherein the rotating step comprises the step of rotating the LIDAR device 360 degrees along the axis of rotation.

19. The object perception method of claim 16, wherein the rotating step comprises the step of rotating the LIDAR device in a single direction along the axis of rotation.

20. The object perception method of claim 16, further comprising the step of translating the LIDAR device while the LIDAR device is rotating along the axis of rotation.
